(19) United States
(12) Patent Application Publication
(10) Pub. No.: US 2007/0003822 A1
(43) Pub. Date: Jan. 4, 2007

(54) Voltage cycling durable catalysts

(76) Inventors: Shyam Kocha, West Henrietta, NY (US); Rohit Makharia, Rochester, NY (US); Hubert A. Gasteiger, Rochester, NY (US)

Correspondence Address: CARY W. BROOKS;General Motors Corporation, Legal Staff, Mail Code 482-C23-B21, P.O. Box 300, Detroit, MI, 48265-3000, US

(21) Appl. No.: 11/172,504

(22) Filed: Jun. 30, 2005

(51) Int. Cl. H01M 4/92; H01M 4/96; H01M 4/88

(52) U.S. Cl. 429/44; 429/42; 502/101

(57) ABSTRACT

A fuel cell electrocatalyst layer having increased voltage cycling durability. The electrocatalyst layer comprises annealed platinum particles having an average particle size diameter from about 3 to about 15 nm deposited on a support structure. The platinum particles are annealed at a temperature from about 800 to about 1,400° C. for a time period such that the surface area is reduced by about 20% as compared to the original surface area. In various embodiments, the electrocatalyst layer retains an electrochemical surface area that is greater than 50% of an original electrochemical surface area after about 15,000 voltage cycles in the range from about 0.6 to about 1.0 V.

### FIELD OF THE INVENTION

The present invention relates to fuel cell catalysts, and more particularly to a voltage cycling durable catalyst.

### BACKGROUND OF THE INVENTION

Electrochemical cells, such as fuel cells, generate electrical power through the electrochemical reaction of a reactant and an oxidant. An exemplary fuel cell has a membrane electrode assembly (MEA) with catalytic electrodes and a proton exchange membrane (PEM) sandwiched between the electrodes. In preferred PEM type fuel cells, hydrogen is supplied as a reductant to an anode and oxygen is supplied as an oxidant to a cathode. PEM fuel cells reduce oxygen at the cathodes and generate an energy supply for various applications, including vehicles. The performance of the reduction reaction directly influences the voltage and power output of a fuel cell stack, and the performance of the cathode is a function of the catalytic properties of an electrocatalyst disposed near each electrode. Typically the electrocatalysts include precious metals, such as platinum and its alloys, homogeneously dispersed on a corrosion resistant substrate layer, such as carbon.

Platinum is thermodynamically unstable and can dissolve at high voltages near 1V in a small voltage regime at low pHs as reported in the Pourbaix diagrams. Therefore, holding a platinum/carbon catalyst at a high potential for a long period of time leads to platinum dissolution. The platinum dissolves and redeposits on larger deposits, or moves into the membrane area of the fuel cells. While the stability of platinum and platinum alloys under stationary conditions is satisfactory, particularly at the lower operating temperatures from about 80 to about 100° C., the frequent load cycles, or voltage cycles, in automotive applications leads to additional and accelerated platinum surface area losses. The impact of voltage cycling on known platinum catalysts has been shown to decrease the amount of platinum surface area by up to 60-70% or more of the original platinum surface area within 10,000 voltage cycles between 0.6 and 1.0V. Catalysts should have a durability or lifetime from about 5,000 to about 10,000 hours, which correlates to upwards of one million or more voltage cycles. Thus, there is a need for voltage cycling durable catalysts that better maintain a sufficient electrochemical reaction-catalyzing surface area after repeated load cycles.

### SUMMARY OF THE INVENTION

The present invention provides a fuel cell electrocatalyst layer comprising annealed platinum particles having an average particle size diameter from about 3 to about 15 nm deposited on a support structure. The platinum particles are heat treated, or annealed, at a temperature from about 800 to about 1,400° C. for a time period such that a post-anneal surface area is less than about 80% of a pre-anneal surface area. In certain embodiments, the support structure comprises an organic material, an inorganic material, or both. Preferably, the support structure has a surface area greater than 5 m²/g. In various other embodiments, the support structure comprises a carbon material having a surface area from about 50 to about 2,000 m²/g.

In another embodiment, the present invention provides a fuel cell comprising an anode, a cathode, a proton exchange membrane disposed between the anode and the cathode, and at least one electrocatalyst layer disposed adjacent to one or both of the anode and cathode. The electrocatalyst layer comprises platinum particles having an average particle size diameter from about 3 to about 15 nm. The platinum particles are annealed to a temperature from about 800 to about 1,400° C. In various embodiments, an electrochemical surface area of the electrocatalyst layer is greater than 50% of an original electrochemically active surface area after about 15,000 voltage cycles in the range from about 0.6 to about 1.0 V.

The present invention also provides a method for increasing the voltage cycling durability of a fuel cell. The method includes providing an electrocatalyst support structure comprising annealed platinum catalyst particles having an average particle size diameter from about 3 to about 15 nm, preferably from about 4 to about 8 nm. In a preferred aspect, the platinum catalyst particles are annealed at a temperature from about 800 to about 1,400° C. in the presence of a heat treatment gas for a time such that a post-anneal surface area is less than about 80% of a pre-anneal surface area. In various alternate embodiments, the particles are heat treated such that a post-anneal particle size diameter is increased preferably greater than 20% of a pre-anneal particle size diameter.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic, exploded, isometric illustration of a liquid-cooled proton exchange membrane;

FIG. 2 is a chart comparing normalized electrochemical surface areas of various electrocatalysts versus a number of voltage cycles in the range of 0.6 to 1.0V; and

FIG. 3 is a chart comparing absolute electrochemical surface areas of various electrocatalysts versus a number of voltage cycles in the range of 0.6 to 1.0V.

### DETAILED DESCRIPTION OF THE PREFERRED EMBODIMENTS

The following description of the preferred embodiment(s) is merely exemplary in nature and is in no way intended to limit the invention, its application, or uses.

In one aspect, the present invention relates to a fuel cell electrocatalyst layer exhibiting increased voltage cycling durability. The electrocatalyst layer comprises annealed platinum particles having an average particle size diameter from about 3 to about 15 nm deposited on a support structure. The platinum particles are heat treated, or annealed, at a temperature from about 800 to about 1,400° C. for a time period such that a post-anneal surface area is less than about 80% of a pre-anneal surface area. In various embodiments, the electrocatalyst layer retains an electrochemically active surface area that is greater than 50% of an original, or post annealed, electrochemically active surface area after about 15,000 voltage cycles in the range from about 0.6 to about 1.0V. Before describing the invention in detail, it is useful to understand the basic elements of an exemplary fuel cell and components of the electrocatalyst layer and its surroundings.

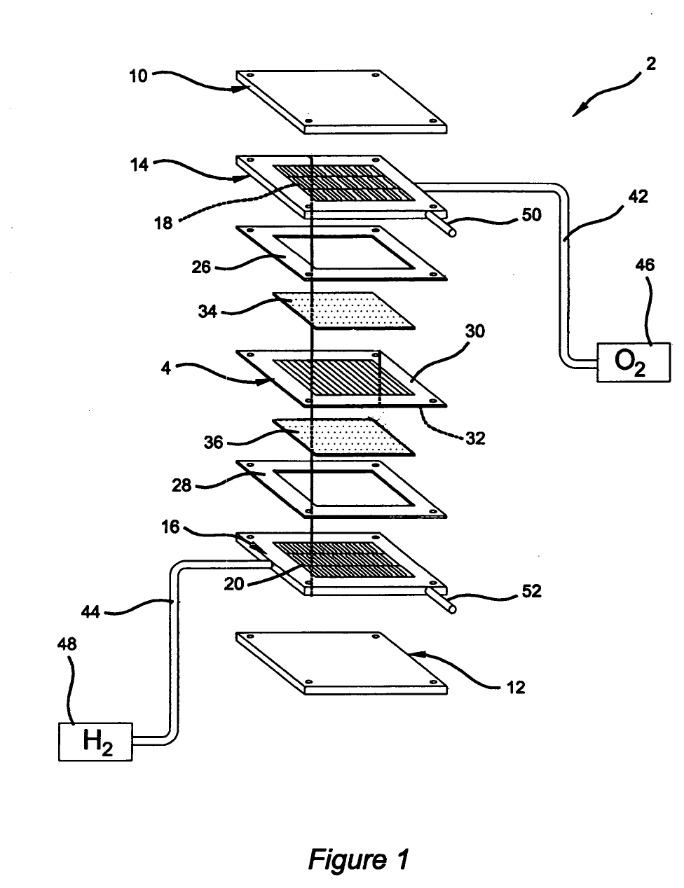

Referring generally to FIG. 1, an exemplary single cell, bipolar proton exchange membrane (PEM) fuel cell stack 2 is depicted having a membrane-electrode-assembly (MEA) 4. An MEA 4 typically consists of anode and cathode electrodes, anode and cathode diffusion media and a PEM. Principally two different methods may be used to prepare an MEA consisting of these five layers: (i) direct application of electrodes onto the membrane, resulting in a so-called catalyst coated membrane (CCM), which is then sandwiched between two diffusion media or (ii) direct application of electrodes onto pre-treated diffusion media, resulting in so-called catalyst-coated substrates (CCS), which are then laminated onto each side of a membrane. The MEA 4 is separated from other fuel cells (not shown) in a stack by electrically conductive, liquid-cooled, bipolar plates 14, 16. The MEA 4 and bipolar plates 14, 16 are stacked together between stainless steel clamping plates 10 and 12. At least one of the working faces of the conductive bipolar plates 14, 16 contains a plurality of grooves or channels 18, 20 for distributing fuel and oxidant gases (e.g., H₂ and O₂) to the MEA 4. Nonconductive gaskets 26, 28 provide seals and electrical insulation between the several components of the fuel cell stack. Gas permeable carbon/graphite diffusion layers 34, 36 press up against the electrode faces 30, 32 of the MEA 4. The electrically conductive bipolar plates 14 and 16 press up against the carbon/graphite paper diffusion layers 34 and 36 respectively. Oxygen is supplied to the cathode side of the fuel cell stack from storage tank 46 via appropriate supply plumbing 42, while hydrogen is supplied to the anode side of the fuel-cell from storage tank 48, via appropriate supply plumbing 44. Alternatively, air may be supplied to the cathode side from the ambient, and hydrogen to the anode from a methanol or gasoline reformer, or the like. Exhaust plumbing (not shown) for both the H₂ and O₂/air sides of the MEA 4 are also provided. Additional plumbing 50, 52 is provided for supplying liquid coolant to the bipolar/end conductive plates 14, 16. Appropriate plumbing for exhausting coolant from the end plates 14, 16 is also provided, but not shown.

Preferred PEM membranes are constructed of a proton-conductive polymer, which is well known in the art. This polymer is essentially an ion exchange resin that includes ionic groups in its polymeric structure that enables cation mobility through the polymer. One commercial proton-conductive membrane suitable for use as a PEM is sold by E. I. DuPont de Nemours & Co. under the trade designation NAFION®. Other proton conductive membranes are likewise commercially available for selection by one of skill in the art.

According to one aspect of the present invention, electrocatalyst layers are disposed adjacent opposing faces of the electrodes and typically comprise a support layer having very finely divided catalytic particles, preferably homogeneously dispersed or deposited thereon. Preferred catalytic materials function as a catalyst in both the anode and cathode reactions, such as the platinum and platinum alloys of the present invention. Preferably, the platinum catalyst particles are heat treated, or annealed, to a temperature from about 800 to about 1,400° C., and more preferably they are annealed to a temperature from about 900 to about 1,200° C., for a time such that the annealed platinum particles have a surface area that is at least about 20% lower than a pre-anneal surface area, preferably less than about 70% of a pre-anneal surface area.

Various support structures can be used as are known in the art. In various embodiments of the present invention, the support structure includes conductive oxides, conductive polymers, various forms of carbon, including activated carbon, graphite, carbon nanotubes, finely divided carbon particles, and combinations thereof. The catalyst is preferably supported on the surfaces of the carbon particles, with a proton conductive material intermingled with the catalytic and carbon particles. Anode catalytic particles preferably facilitate hydrogen gas (H₂) dissociation, whereby protons and free electrons are formed. Protons migrate across the PEM to the cathode side for reaction. Cathode catalytic particles foster the reaction between protons and oxygen gas, creating water as a byproduct.

In various preferred embodiments of the present invention, the electrocatalyst support structure can comprise an organic material, an inorganic material, or both. Preferably, the support structure has a surface area greater than about 5 m²/g. In certain embodiments, the electrocatalyst support structures comprise a carbon support material, preferably having a surface area from about 50 to about 2,000 m²/g. Non-limiting examples of carbon materials useful as the support material include graphitized carbon (having a surface area of about 50-300 m²/g), vulcan carbon (having a surface area of about 240 m²/g), Ketjen black carbon (having a surface area of about 800 m²/g), and Black Pearls carbon (having a surface area of about 1,000 m²/g). Graphitized carbon, or carbon that is heated to a temperature from about 2,200 to 2,700° C. is presently preferred and yields a more robust catalyst support. Graphitized carbon has a more ordered structure with a lower surface area, and is less susceptible to corrosion. Because the carbon particles provide an electrical path and support the platinum catalyst particles for catalytic activity, the electrocatalyst layer generally comprises from about 30 to about 90% by weight carbon, preferably from about 50 to about 75% by weight. In terms of the amount of catalyst present, the electrocatalyst layer preferably comprises from about 10 to about 70% by weight platinum, preferably from about 25 to about 50% by weight.

Typically, platinum catalyst particles or platinum-bearing carbon particles are dispersed throughout an ionically-conductive polymer or ionomer that improves current density and typically comprises either a proton conductive polymer and/or a fluoropolymer. In various embodiments, the ionomer: carbon weight ratio is from about 0.8:1 to about 1.2:1 for a carbon supported platinum catalyst. When a proton-conductive material is used, it will typically comprise the same proton-conductive polymer as in the PEM (e.g., NAFION®). The fluoropolymer, if employed, typically comprises polytetrafluoroethylene (PTFE), though others such as FEP (fluorinated ethylene propylene copolymer), PFA (perfluoroalkoxy resin), and PVDF (polyvinylidene fluoride) may also be used. These polymers create a robust structure for catalyst retention, adhere well to the PEM, aid in water management within the cell, and enhance ion exchange capacities of the electrodes. The intimate intermingling of proton conductive material with platinum catalyst carbon particles provides a continuous path for protons to the catalyst sites where reactions occur.

In various embodiments, the platinum particles comprise a platinum alloy selected from the group consisting of: binary platinum alloys; ternary platinum alloys; and mixtures thereof. Non-limiting examples of binary platinum alloys include: PtCo, PtCr, PtV, PtTi, PtNi, PtIr, and PtRh. Similarly, non-limiting examples of ternary platinum alloys include PtCoCr, PtRhFe, PtCoIr, and PtIrCr.

It is known that the platinum surface area is approximately inversely proportional to the platinum particle size. The platinum-particle size effect is well understood in the context of phosphoric acid fuel cells (PAFCs) and describes the observation that the specific activity of platinum in phosphoric acid decreases by a factor of 3 as the platinum-particle size diameter decreases from 12 to 2.5 nm, while the mass activity shows a maximum at 3 nm, consistent with other reports in the PAFC literature. This effect is generally ascribed to the impeding effect of specific anion adsorption on different crystal faces, the distribution of which changes with platinum particle size diameter. In various preferred embodiments of the present invention, the sizes of the annealed platinum particles are homogenous and their average particle size diameter is from about 3 to about 15 nm, more preferably from about 4 to about 8 nm.

When fabricating electrodes with solid polymer electrolytes, it is not likely that all of the intrinsic platinum catalyst surface area, sometimes referred to as the electrochemical area, A_{Pt,cat}, is available for the electrochemical reactions due to either insufficient contact with the solid electrolyte or due to electrical isolation of catalyst particles from each other by a film of the electrically non-conducting solid electrolyte. Therefore, the platinum-surface area measured by cyclic voltammetry in an MEA, A_{Pt,MEA}, using the so-called driven-cell mode may be substantially smaller than the intrinsic surface area of a catalyst, A_{Pt,cat}, and the ratio of A_{Pt,cat}/A_{Pt,MEA} is often referred to as MEA catalyst utilization, u_{Pt}. Reported values for u_{Pt} range from 60-70 to 75-98%, depending on the MEA preparation. Intrinsic catalyst surface areas, A_{Pt,cat}, are reported in terms of m²/g_{Pt}.

To illustrate the unexpected benefits of the invention, specific activities and mass activities were determined for various platinum catalysts to be used in a PEM fuel cell. The values listed in Table 1, below, were calculated at 0.9 V and 80° C. at an O₂ partial pressure of 100 kPa_{abs}. Example 1 is highly dispersed platinum on carbon (˜50% Pt/C); Example 2 is high temperature (1,000° C.) annealed platinum on carbon (˜50% Pt/C-Annealed); Example 3 is high weight percent platinum alloy on carbon (˜50% PtCo/C); Example 4 is low weight percent platinum alloy on carbon (˜30% PtCo/C); and Example 5 is standard low-dispersion platinum on carbon catalyst (˜40% Pt/C low dispersions.

TABLE 1

| | Example 1 | Example 2 | Example 3 | Example 4 | Example 5 |
|---|---|---|---|---|---|
| Pt Surface Area, | 80 | 50 | 50 | 60 | 30 |
| A_{Pt,MEA} (m²/g_{Pt}) | | | | | |
| Specific Activity, i_{s (0.9V)} | 210 | 380 | 560 | 580 | 200 |
| (μA/cm²_{Pt}) | | | | | |
| Mass Activity, i_{m (0.9V)} | 0.16 | 0.19 | 0.28 | 0.35 | 0.07 |
| (A/mg_{Pt}) | | | | | |
| Decrease in | 67 | 23 | 22 | 35 | Not Tested |
| electrochemically | | | | | |
| active surface area | | | | | |
| after 10,000 cycles (%) | | | | | |

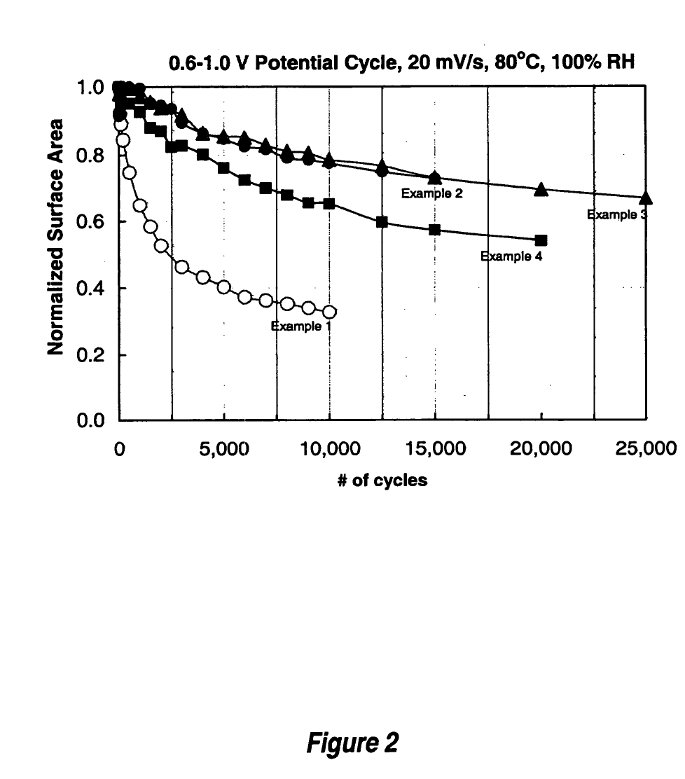

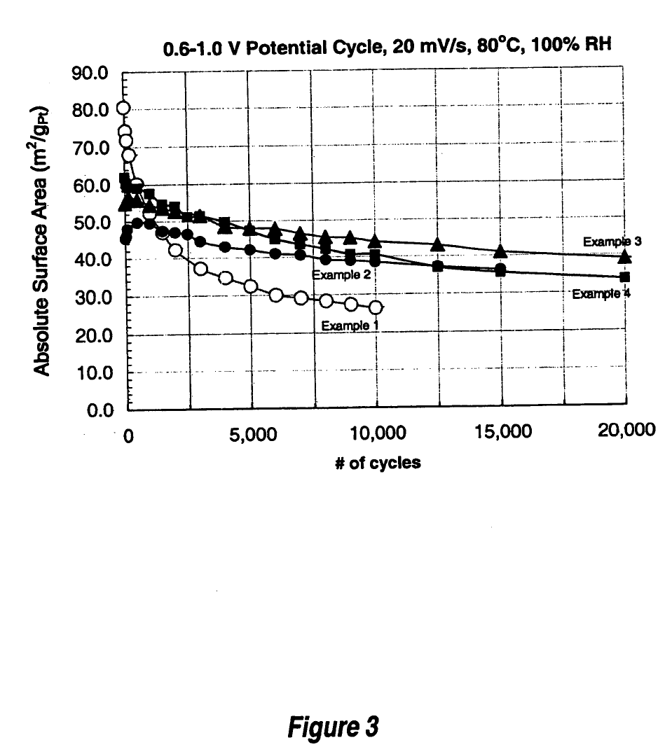

While platinum alloys typically undergo a high temperature annealing step (i.e., 800-1,000° C.) standard platinum catalysts are generally synthesized within a much lower temperature range (i.e., 25-200° C.). As standard platinum catalyst particles are annealed to high temperatures, the platinum particle size diameter increases, and the platinum surface area decreases. This is depicted in Table 1, where the surface area of standard platinum catalyst decreases from 80 m²/g_{Pt} in Example 1, to 50 m²/g_{Pt} in Example 2 after a high temperature annealing step. Unexpectedly, however, the reduced surface area is accompanied by an increased specific activity, so that the mass activity of the annealed platinum catalyst is unexpectedly greater than the standard platinum catalyst. While the annealing step only slightly increases the mass activity, it dramatically improves the voltage cycling durability as shown in FIGS. 2 and 3 and discussed below. It should be noted that a mere increase in platinum particle size diameter due to lower platinum dispersion in a standard platinum catalyst (e.g., Example 5) does not lead to largely reduced mass activity and is not believed to increase voltage cycling durability.

In various embodiments, the electrocatalyst layer preferably has a specific activity greater than about 180 μA/cm²_{Pt}, more preferably, the specific activity is greater than 20 μA/cm²_{Pt}, and even more preferably, greater than 300 μA/cm²_{Pt}. Similarly, the electrocatalyst layer preferably has a mass activity greater than about 0.1 A/mg_{Pt}, more preferably, the mass activity is greater than 0.2 A/mg_{Pt}, and even more preferably, greater than 0.3 A/mg_{Pt}.

In addition to high cell performance, fuel cells generally require highly durable catalysts, preferably with a lifetime of about 5,000 to 10,000 hours under automotive conditions. Under automotive conditions, fuels cells undergo millions of potential cycles, or load cycles, rather than remaining at a fixed load as most typical residential and stationary fuel cell systems. FIG. 2 is a chart comparing normalized electrochemical surface areas of various electrocatalysts versus a number of voltage cycles. The data is obtained using an MEA having an area of 50 cm² with H₂/N₂ operation. The voltage ranged from about 0.6 to about 1.0 V at a potential, cycle of 20 mV/s at 80° C. A, voltage of about 0.6 V is representative of a vehicle running at a high throttle, for example, 100 hp. A voltage of about 1.0 V is representative of the open circuit voltage (OCV), or when the vehicle engine is at a low idle.

As can be seen, various examples illustrate the decrease in the normalized electrochemically active surface area as a function of the number of voltage cycles. The impact of voltage cycling on standard platinum catalysts is illustrated by the reduction of practically 60-70% of the original electrochemically active surface area after about 10,000 voltage cycles between about 0.6 to about 1.0 V. For example, the electrochemically active surface area of Example 1 decreased about 67% after 10,000 voltage cycles. The electrochemically active surface area similarly decreased for Examples 2-4 as shown in Table 1. In various embodiments using an electrocatalyst according to the present invention, the electrochemically active surface area of the electrocatalyst remains greater than 50% of an original, or post annealed, electrochemically active surface area even after 15,000 and 20,000 voltage cycles.

FIG. 3 is a chart comparing the absolute electrochemical surface areas of various electrocatalysts versus a number of voltage cycles in the range of 0.6 to 1.0V. As can be seen, while the electrocatalyst layers according to the present invention do not have the greatest initial electrochemically active surface area, they maintain greater than 50% of the original electrochemically active surface area after 15,000 and 20,000 voltage cycles.

The present invention also provides a method of increasing voltage cycling durability of a fuel cell. The method comprises annealing platinum catalyst particles on carbon, forming platinum/carbon electrocatalyst particles having an average particle size diameter from about 3 to about 15 nm. An electrocatalyst support structure comprising annealed platinum/carbon electrocatalyst particles is provided in a PEM fuel cell. The support structure is formed using common techniques known in the art. One non-limiting example includes forming a catalyst ink, or an aqueous solution containing the platinum/carbon electrocatalyst particles with an organic solvent, deionized water, and an ionomer solution. Suitable organic solvents include methanol, ethanol, iso-propanol, diethyl ether, and acetone. The ink is typically ball-milled for about 12-20 hours and coated on an MEA or diffusion media, as desired, for use in a PEM fuel cell.

In various embodiments, the platinum particles have an average original particle size diameter from about 1 to about 4.5 nm, prior to annealing. After heat treatment, the average annealed particle size diameter is preferably from about 4 to about 8 nm. Preferably, the platinum catalyst particles are annealed at a temperature from about 800 to about 1,400° C. and more preferably they are annealed at a temperature from about 900 to about 1,200° C., for a time sufficient to increase the size of the platinum/carbon electrocatylst particles such that a post-anneal surface area is less than about 80% of a pre-anneal surface area of the platinum particles. In various embodiments, the platinum particles are heat treated, or annealed, for a duration from about 0.5 to about 10 hours or longer, preferably from about 1 to about 3 hours.

During the annealing process, it is preferred to protect the platinum from oxidation by replacing the atmosphere of air with a controlled atmosphere, such as a nonoxidizing gas. A gaseous atmosphere that is nonoxidizing may be one of several varieties. It can be an inert gas or nonreactive gas that forms no compounds, for example helium, neon, or argon. It could also be a gas that has no tendency to react with the platinum. Another type of gas is known in the art as a reducing gas that will not only protect the platinum from oxidation, but will also reduce any oxide that may already exist on the particle surface. It should be understood that before a gas can be selected for use as a controlled atmosphere, its properties and its effect on the platinum particles should be determined. In various embodiments, the platinum catalyst particles are annealed in the presence of a heat treatment gas selected from the group consisting of: an inert gas; a reducing gas; hydrogen; and mixtures thereof. Preferred combinations include (1) hydrogen gas only; (2) an inert gas only; (3) an inert gas with a reducing gas; or (4) an inert gas with hydrogen and a reducing gas (e.g., carbon monoxide).

In various alternate embodiments, it may be desirable to eliminate the surrounding atmosphere during the annealing process. This may be accomplished by using vacuum techniques as known in the art. Even a mediocre vacuum may cause less oxide formation than an artificial atmosphere which may be 99.9% inert gas. As used herein, a vacuum refers to a reduced pressure as compared to the atmospheric pressure.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A fuel cell electrocatalyst layer comprising:
annealed platinum particles having an average particle size diameter from about 3 to about 15 nm deposited on a support structure, wherein the annealed platinum particles have a surface area that is less than about 80% of a pre-anneal surface area.

2. The electrocatalyst layer according to claim 1, wherein the average particle size diameter is from about 4 to about 8 nm.

3. The electrocatalyst layer according to claim 1, wherein the platinum particles have been heat treated at a temperature from about 800 to about 1,400° C.

4. The electrocatalyst layer according to claim 1, wherein the support structure has a surface area greater than about 5 m²/g.

5. The electrocatalyst layer according to claim 4, wherein the support structure comprises a carbon material having a surface area from about 50 to about 2,000 m²/g.

6. The electrocatalyst layer according to claim 1, wherein the support structure comprises at least one of: carbon, activated carbon, graphite, carbon nanotubes, ionomers, conductive oxides, conductive polymers, and combinations thereof.

7. The electrocatalyst layer according to claim 1, wherein a specific activity of the electrocatalyst is greater than about 180 μA/cm² of platinum.

8. The electrocatalyst layer according to claim 1, wherein a mass activity of the electrocatalyst is greater than about 0.1 μA/mg of platinum.

9. The electrocatalyst layer according to claim 1, wherein an electrochemically active surface area of the electrocatalyst is greater than 50% of an original electrochemically active surface area after about 15,000 voltage cycles in the range from about 0.6 to about 1.0 V.

10. The electrocatalyst layer according to claim 1, wherein the platinum particles comprise at least one of: binary platinum alloys, ternary platinum alloys, and mixtures thereof.

11. A fuel cell comprising:
an anode;
a cathode;
a proton exchange membrane disposed between the anode and cathode; and
at least one electrocatalyst layer disposed adjacent to the anode or the cathode or both the anode and the cathode,
wherein the electrocatalyst layer comprises platinum particles having an average particle size diameter from about 3 to about 15 nm that have been annealed at a temperature from about 800 to about 1,400° C.

12. The fuel cell according to claim 11, wherein an electrochemically active surface area of the electrocatalyst layer is greater than 50% of an original electrochemically active surface area after about 15,000 voltage cycles in the range from about 0.6 to about 1.0 V.

13. The fuel cell according to claim 11, wherein the platinum particles comprise at least one of: binary platinum alloys, ternary platinum alloys, and mixtures thereof.

14. The fuel cell according to claim 11, wherein the electrocatalyst layer comprises a support structure containing a carbon material having a surface area from about 50 to about 2,000 m²/g.

15. A method of increasing the voltage cycling durability of a fuel cell, the method comprising:
annealing platinum catalyst particles on carbon at a temperature from about 800 to about 1,400° C. to form annealed platinum/carbon electrocatalyst particles having an average particle size diameter from about 3 to about 15 nm;
preparing an electrocatalyst support structure comprising the annealed platinum/carbon electrocatalyst particles and including the electrocatalyst support structure in a PEM fuel cell.

16. The method according to claim 15, wherein the platinum/carbon electrocatalyst particles are annealed having an average particle size diameter from about 4 to about 8 nm.

17. The method according to claim 16, wherein the platinum catalyst particles have an average particle size diameter from about 1 to about 4.5 nm prior to annealing.

18. The method according to claim 15, wherein the platinum catalyst particles are annealed for about 1 to about 3 hours.

19. The method according to claim 15, wherein the platinum catalyst particles are annealed for a time such that a post-anneal surface area of the particles is less than about 80% of a pre-anneal surface area of the particles.

20. The method according to claim 15, wherein the platinum catalyst particles are annealed in the presence of: an inert gas, a reducing gas, hydrogen, or a mixture thereof.
